(19) United States
(12) Patent Application Publication
(10) Pub. No.: US 2006/0054138 A1
(43) Pub. Date: Mar. 16, 2006

(54) Fuel injection system with integrated pressure booster

(76) Inventor: Gerhard Geyer, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/532,503

(22) PCT Filed: Jul. 28, 2003
(86) PCT No.: PCT/DE03/02530

§ 371 Date: Apr. 25, 2005

(30) Foreign Application Priority Data
Nov. 8, 2002 (DE) 102 51 932.3

(51) Int. Cl. F02M 57/02

(52) U.S. Cl. 123/446

(57) ABSTRACT

A fuel injection system for internal combustion engines, having a fuel injector that can be supplied from a high-pressure source includes a pressure boosting system containing a booster piston connected between the fuel injector and the high-pressure fuel source. The booster piston divides a chamber, connected to the high-pressure fuel source, from a high-pressure chamber communicating with the fuel injector and from a differential pressure chamber. The actuation of the pressure boosting system is effected via a 2/2-way valve assigned to the differential pressure chamber. For refilling of the differential pressure chamber and the high-pressure chamber of the pressure boosting system, hydraulically actuated check valves are provided, which upon pressure relief of the differential pressure chamber are acted upon hydraulically via a flow connection that branches off from the high-pressure chamber of the pressure boosting system.

### FIELD OF THE INVENTION

For introducing fuel into combustion chambers of self-igniting internal combustion engines, both pressure-controlled and stroke-controlled injection systems may be employed. Injection systems that include a high-pressure reservoir have the advantage that the injection pressure can be adapted to the engine load and rpm. To reduce emissions and to attain high specific performance of the engine, a high injection pressure is necessary. Since the pressure level attainable in the high-pressure reservoir by high-pressure fuel pumps is limited for reasons of strength, it is possible, to further increase the pressure in fuel injection systems with a high-pressure reservoir, to assign a pressure booster to the fuel injector.

### BACKGROUND OF THE INVENTION

German Patent Disclosure DE 101 23 911.4 relates to a fuel injection system with a pressure boosting system and to a pressure boosting system. The fuel injection system for internal combustion engines includes a fuel injector that can be supplied from a high-pressure fuel source. Between the fuel injector and the high-pressure fuel source, there is a pressure boosting system that includes a movable piston. The movable piston divides a chamber connected to the high-pressure fuel source from both a high-pressure chamber, communicating with the injector, and a back chamber. The high-pressure chamber of the pressure boosting system can be made to communicate with the back chamber via a fuel line. The fuel line includes a valve which is embodied in particular as a check valve, so that a return flow of fuel from the high-pressure chamber into the back chamber can be prevented. In this embodiment, both the pressure boosting system and a fuel injector are each actuated via a separate 2/2-way valve.

### SUMMARY OF THE INVENTION

With the embodiment proposed according to the invention, a pressure-boosted injection system can be furnished whose triggering is effected via a simple 2/2-way magnet valve and which has two simple, hydraulically actuated check valves for controlling the injection valve member and for refilling the pressure boosting system. The injection system proposed according to the invention can be employed wherever either shaping of the injection course is unnecessary, or the expense for it appears too high compared to the attainable usefulness in the internal combustion engine. When the embodiment proposed according to the invention is used, one magnet valve per injector, including the requisite end stage in the control unit, can be dispensed with without having to sacrifice the advantages of pressure boosting at the fuel injector. One application would be—to name one example—using exhaust gas recirculation means in internal combustion engines.

In the embodiment according to the invention, a throttle restriction can be dispensed with. The disposition of the simple, hydraulically actuated valves, permits faster triggering of a fuel injector of a high-pressure injection system in a way that is free of outflow losses. The more the outflow losses can be kept to low values, the better the hydraulic efficiency of an injection system is.

### DRAWING

The invention will be described in further detail below in conjunction with the drawing.

Shown are:

FIG. 1, a fuel injection system in which one separate 2/2-way valve is used for triggering the pressure booster and for triggering the fuel injector;

FIG. 2, the fuel injection system proposed according to the invention, with a 2/2-way valve, a compensation valve, and a filling valve, in the position of repose;

FIG. 3, the fuel injection system of FIG. 2, with current supplied to the 2/2-way valve;

FIG. 4, the fuel injection system of FIG. 2, with the magnet valve currentless and with the nozzle needle closing;

FIG. 5, the fuel injection system, with an opening compensation valve and an opening filling valve;

FIG. 6, the fuel injection system, with a closing filling valve after refilling of the high-pressure chamber; and

FIG. 7, a variant embodiment of the fuel injection system proposed according to the invention, with spring-loaded check valves integrated with the booster piston.

### VARIANT EMBODIMENTS

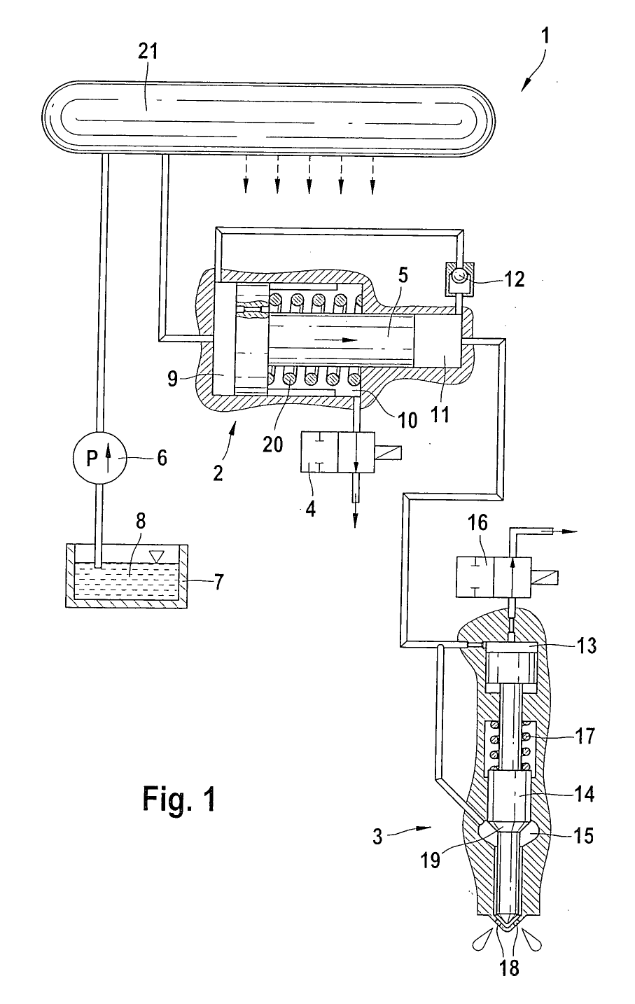

FIG. 1 shows a fuel injection system in which one separate 2/2-way valve is used for triggering the pressure booster and for triggering the fuel injector.

The fuel injection system 1 shown in FIG. 1 includes a pressure boosting system 2 as well as a fuel injector identified by reference numeral 3. The triggering of the pressure boosting system 2 is effected via a first 2/2-way valve 4, which may for instance be in the form of a magnet valve. The pressure boosting system 2 includes a booster piston 5, which divides a work chamber 9 from a differential pressure chamber 10 (back chamber) and a high-pressure chamber 11. An overflow of fuel from the high-pressure chamber 11, acted upon by the booster piston 5, into the work chamber 9 of the pressure boosting system 2 is prevented via a check valve 12. The booster piston 5 is acted upon by a restoring spring 20, which is received in the differential pressure chamber 10 (back chamber) of the pressure boosting system 2.

The work chamber 9 of the pressure boosting system 2 is acted upon by a high-pressure fuel source 21, such as a high-pressure reservoir in common-rail fuel injection systems. The high-pressure reservoir 21 is in turn acted upon by fuel via a high-pressure pump 6. The high-pressure pump 6 pumps fuel from a fuel tank 7 that contains a fuel supply 8.

A high-pressure line extends from the high-pressure chamber 11 of the pressure boosting system 2 and discharges, with the interposition of a throttle restriction, into a control chamber 13 at the fuel injector 3. A pressure relief of the control chamber 13 of the fuel injector 3 is effected via a separate, second triggering valve 16, which may likewise be designed as a 2/2-way magnet valve. The high-pressure line branching off from the high-pressure chamber 11 of the pressure boosting system 2 simultaneously acts on a nozzle chamber 15 that surrounds an injection valve member 14 of the fuel injector 3. The nozzle chamber 15 changes over into an annular gap, which surrounds the injection valve member 14 and acts on injection openings 18 that are provided on the end toward the combustion chamber of the fuel injector 3. The injection valve member 14 of the fuel injector 3 includes a pressure shoulder 19 surrounded by the nozzle chamber 15. Upon pressure relief of the control chamber 13 by switching of the triggering valve 16 of the fuel injector 3, the injection valve member 14, embodied for instance as a nozzle needle, opens, and uncovers the injection openings 18 toward the combustion chamber, so that via the nozzle chamber 15, fuel that is at high pressure can be injected into the combustion chamber of the self-igniting internal combustion engine. The fuel injector 3 includes a compression spring 17, which acts upon the injection valve member 14 and upon actuation of the 2/2-way valve of the pressure boosting system 2 into its closing position and upon actuation of the triggering valve 16 of the fuel injector 3 into its closing position and with the resultant pressure buildup in the control chamber 13 brings about a closure of the injection valve member 14 in its seat toward the combustion chamber and terminates the injection.

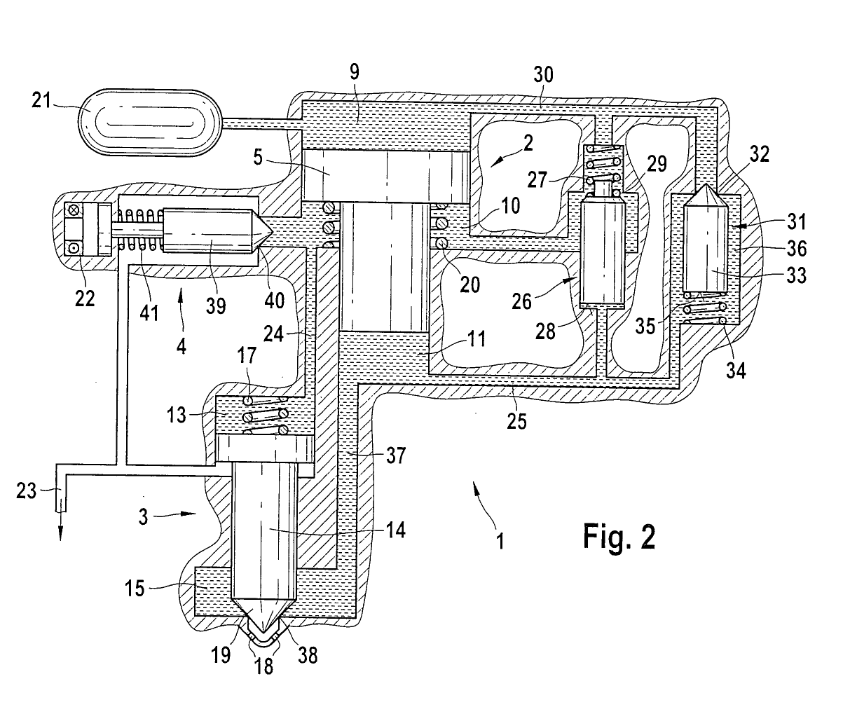

FIG. 2 shows the fuel injection system, proposed according to the invention, with a 2/2-way valve and two hydraulically actuated check valves in the position of repose.

The fuel injection system 1 proposed according to the invention includes the pressure boosting system 2, the fuel injector 3, and the 2/2-way valve 4 for actuating the pressure boosting system 2. The booster piston 5 which divides the work chamber 9 of the pressure boosting system 2 from the differential pressure chamber 10 (back chamber) and the high-pressure chamber 11 of the pressure boosting system 2 is received inside the pressure boosting system 2. The work chamber 9 is acted upon by fuel at high pressure via a high-pressure reservoir 21 (common rail). The booster piston 5 of the pressure boosting system 2 is acted upon by a restoring spring 20. An overflow line 24 extends from the differential pressure chamber 10 (back chamber) of the pressure boosting system 2, and by way of it the differential pressure chamber 10 of the pressure boosting system 2 and the control chamber 13 of the fuel injector 3 communicate hydraulically. The spring element 17 that acts upon the upper face end of the injection valve member 14, which can for instance be embodied as a nozzle needle, is received inside the control chamber 13 of the fuel injector 3. The differential surface area on the injection valve member 14 is in communication with a return 23 on the low side. The injection valve member 14 of the fuel injector 3 is surrounded by the nozzle chamber 15. A differential surface area 19 is embodied on the injection valve member 14 and may for instance be in the form of a pressure shoulder. In the position of repose, shown in FIG. 2, of the fuel injection system 1 proposed according to the invention, the injection valve member 14 closes a seat 38 toward the combustion chamber, so that via the closed injection openings 18, no fuel can be injected into the combustion chamber of a self-igniting internal combustion engine.

The magnet valve 4, in the form of a 2/2-way valve, assigned to the differential pressure chamber 10 (back chamber) of the pressure boosting system 2 includes a valve body 39, which is acted upon via a restoring spring 41. Via the restoring spring 41, the valve body 39 of the 2/2-way magnet valve 4, in the state without current, is put into its seat 40 that closes the differential pressure chamber 10 (back chamber) of the pressure boosting system 2. When current is supplied to a magnet coil 22 of the 2/2-way valve 4, the opening of the seat 40 of the 2/2-way magnet valve 4 occurs, so that a pressure relief of the differential pressure chamber 10 (back chamber) of the pressure boosting system 2 can be effected into the low-side return 23. The low-side return 23 communicates with a fuel reservoir, not shown in FIG. 2, to which the diverted fuel flows.

The pressure boosting system 2 includes the high-pressure chamber 11, which acts on the nozzle chamber 15 of the fuel injector 3 via a nozzle chamber inlet 37. A flow connection 25 also branches off from the high-pressure chamber 11 of the pressure boosting system 2. The flow connection 25 extends both to a compensation valve 26, embodied as a check valve, and to a filling valve 31, likewise embodied as a hydraulically actuated check valve. Via the flow connection 25, one end face 28 of the compensation valve 26 and one end face 35 of the filling valve 31 are acted upon hydraulically.

The compensation valve 26 embodied as a hydraulically actuated check valve is acted upon a spring element 27 and includes a seat 29, which can be either uncovered or closed. A chamber which communicates hydraulically with the differential pressure chamber 10 (back chamber) of the pressure boosting system 2 is embodied at the compensation valve 26. By means of the spring element 27 assigned to the compensation valve 26, the valve body of the compensation valve 26 is prestressed counter to a hydraulic force engaging the face end 28. The filling valve 31, which can likewise be acted upon via the flow connection 25, includes a chamber 36, in which a spring element 34 is received that acts upon the face end 35 of the valve body 33 of the filling valve 31. By means of the spring element 34, the valve body 33 of the filling valve 31 is kept in its seat 32 in the closing position.

Both the compensation valve 26 and the filling valve 31 communicate fluidically with the work chamber 9 of the pressure boosting system 2 via a further connecting line 30.

In the position of repose shown in FIG. 2 of the fuel injection system 1 proposed according to the invention, the 2/2-way magnet valve 4 is not supplied with current and is put into its seat 40 by the restoring spring 41. Thus the differential pressure chamber 10 (back chamber) of the pressure boosting system 2 is closed. Because of the opened seat 29 at the compensation valve 26, the same pressure prevails in the work chamber 9 of the pressure boosting system 2 and in the differential pressure chamber 10 (back chamber) of the pressure boosting system 2 as in the high-pressure chamber 11 of the pressure boosting system 2 that was previously filled via the filling valve 31. The high-pressure chamber 11 communicates with the nozzle chamber 15 of the fuel injector 3 via the nozzle chamber inlet 37. Since the control chamber 13 of the fuel injector 3 is acted upon by the differential pressure chamber 10 (back chamber) of the pressure boosting system 2 via the overflow line 24, the injection valve member 14 is kept in its closing position in the state of repose of the fuel injection system 1 proposed according to the invention. The surface area of the upper face end of the injection valve member 14, which area defines the control chamber 13 of the fuel injector 3, exceeds the effective differential surface area 19 (pressure shoulder) at the injection valve member 14 in the nozzle chamber 15, and hence the forces that act in the closing direction predominate.

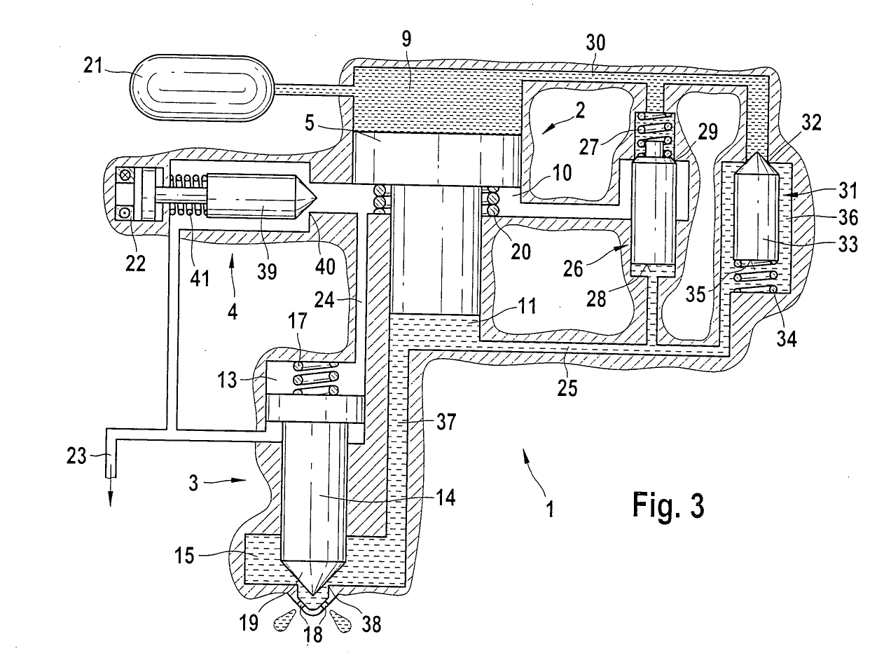

FIG. 3 shows the fuel injection system of FIG. 2 when current is supplied to the 2/2-way valve.

In the switching state shown in FIG. 3 of the fuel injection system 1, the 2/2-way valve 4 is supplied with current; that is, the armature opposite the magnet coil and connected to the valve body 39 is attracted by the magnet coil 22 counter to the action of the restoring spring 41. As a result, the valve body 39 of the 2/2-way valve 4 moves out of its seat 40. As a result, the differential pressure chamber 10 (back chamber) of the pressure boosting system 2 is pressure-relieved, and also fuel flows out of the control chamber 13, which via the overflow line 24 is in communication with the differential pressure chamber 10 (back chamber) of the pressure boosting system 2, into the low-side return 23. Because of the pressure relief of the differential pressure chamber 10 (back chamber) of the pressure boosting system 2, the booster piston 5 moves into the high-pressure chamber 11. As a function of the ratio of surface area at the booster piston 5, a further-increased pressure is generated in the high-pressure chamber 11, compared to the pressure prevailing in the high-pressure source 21. The further-increased pressure generated in the high-pressure chamber 11 of the pressure boosting system 2 prevails, via the nozzle chamber inlet 37, in the nozzle chamber 15 of the fuel injector 3. The further-increased pressure prevailing in the high-pressure chamber 11 is likewise applied, via the flow connection 35, to the face end 28 of the valve body of the hydraulically actuated compensation valve 26 and moves that valve into its seat 29, so that the compensation valve 26 is closed. The filling valve 31 is pressed into its seat 32 as well by the further-increased pressure prevailing in the flow connection 25.

Because of the further-increased pressure prevailing in the high-pressure chamber 11 and because of the decreasing pressure in the control chamber 13 of the fuel injector 3, the hydraulic forces applied to the differential surface area 19 (pressure shoulder) of the injection valve member 14 predominate over the closing forces exerted via the spring element 17, so that the injection valve member 14, which can for instance be embodied as a nozzle needle, moves vertically upward and opens the injection openings 18 on the end toward the combustion chamber of the fuel injector 3. The injection event is symbolically represented in FIG. 3 by the fuel droplets emerging from the injection openings 18. During the event of injection of fuel at a further-increased pressure via the injection openings 18 into the combustion chamber of the self-igniting engine, the compensation valve 26 and the filling valve 31 both remain closed, because of the further-increased pressure prevailing in the flow connection 25. The further-increased fuel pressure generated in the high-pressure chamber 11 of the pressure boosting system 2 acts via the flow connection 25 on the face ends 28 and 35 of the compensation valve 26 and the filling valve 31, respectively. Their respective seats 29 and 32 are closed, so that the further-increased pressure generated in the high-pressure chamber 11 is incapable of flowing out via the connecting line 30.

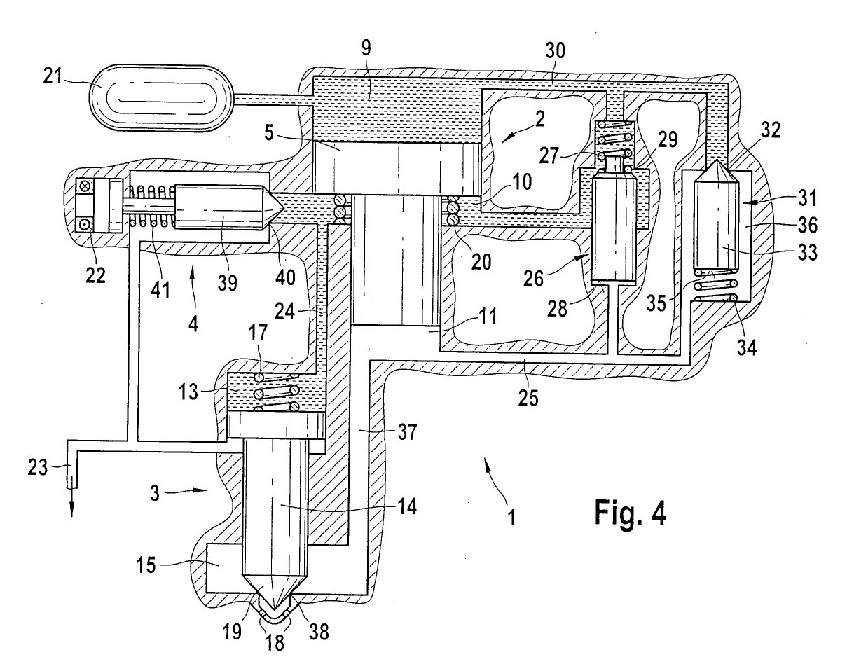

FIG. 4 shows the fuel injection system, proposed according to the invention, of FIG. 2 with the 2/2-way valve not supplied with current and with the injection valve member 14 closing.

If the 2/2-way valve 4 comes to be without current, the valve body 39 of the 2/2-way valve 4 moves into its seat 40 and closes the differential pressure chamber 10 (back chamber) of the pressure boosting system 2. Because of the in the differential pressure chamber 10 (back chamber) by the outflow now closed via the 2/2-way valve 4, pressure builds up in the differential pressure chamber 10 (back chamber), and the booster piston 5 is stopped in its downward motion. Because of the spring element 17 received in the control chamber 13 and because of the increasing pressure in the course of the refilling in the differential pressure chamber 10 (back chamber) and in the control chamber 13 brought about by the opening compensation valve 26, the injection valve member 14 is moved back into its seat 38 toward the combustion chamber. Thus the injection openings 18 on the end of the fuel injector 3 toward the combustion chamber are closed; the injection of fuel is terminated. The hydraulic forces prevailing in the control chamber 13 and the closing force exerted via the spring element 17 on the upper face end of the injection valve member 14 move the injection valve member 14 into the closing position, back into the seat 38 toward the combustion chamber.

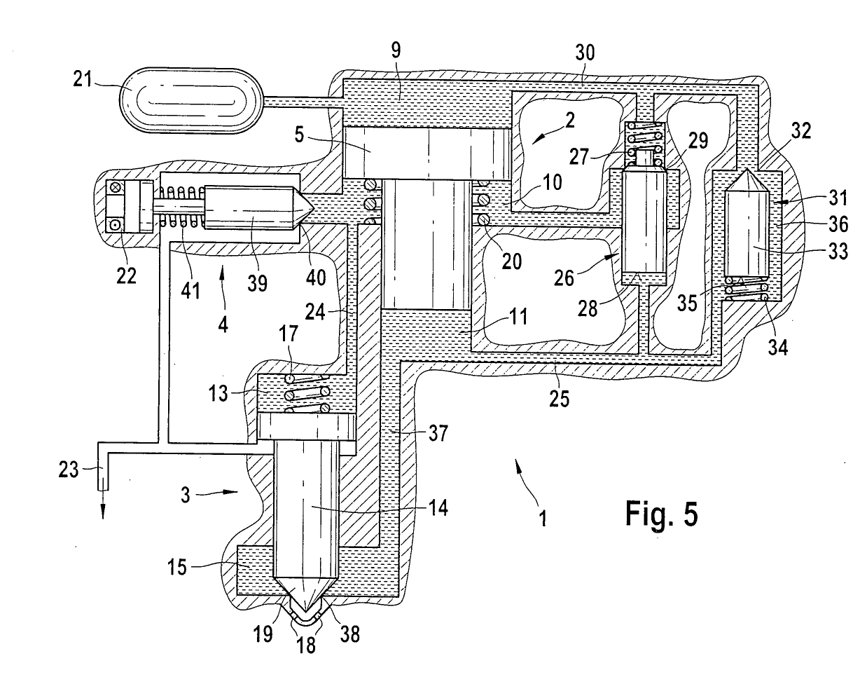

FIG. 5 shows the fuel injection system with the filling valve opening.

When there is no current to the 2/2-way valve 4 (as shown in FIG. 4), refilling of the differential pressure chamber 10 (back chamber) of the pressure boosting system 2 takes place via the work chamber 9 and the connecting line 30 extending from it to the compensation valve 26. Because of the pressure applied from the work chamber 9 via the connecting line 30 and reinforced by the spring element 27 urging the valve body of the compensation valve 26 in the opening direction, the spring element opens at its seat 29, so that fuel flows into the differential pressure chamber 10 (back chamber) of the pressure boosting system 2.

Because of the dropping pressure in the high-pressure chamber 11 of the pressure boosting system 2, opening of the compensation valve 26 at its seat 29 and filling of the differential pressure chamber 10 (back chamber) are effected. The filling valve 31 now also opens. The valve body 33 of the filling valve 31 is exposed to the fuel pressure that is effective in the work chamber of the pressure boosting system 2; this pressure is higher than the closing force that is exerted on the face end 35 of the valve body 33 via the spring element 34. Because of the dropping pressure in the high-pressure chamber 11 of the pressure boosting system 2, the hydraulic component of the closing force engaging the face end 35 of the valve body 33 decreases steadily, so that the valve body 33 of the filling valve 31 moves out of its seat 32. Via the connecting line 30 from the work chamber 9 of the pressure boosting system 2, fuel flows into the chamber 36 surrounding the valve body 33 of the filling valve 31 and flows to the high-pressure chamber 11 as well as to the nozzle chamber 15 of the fuel injector 3. As a result, refilling of the high-pressure chamber 11 of the pressure boosting system 2 is effected.

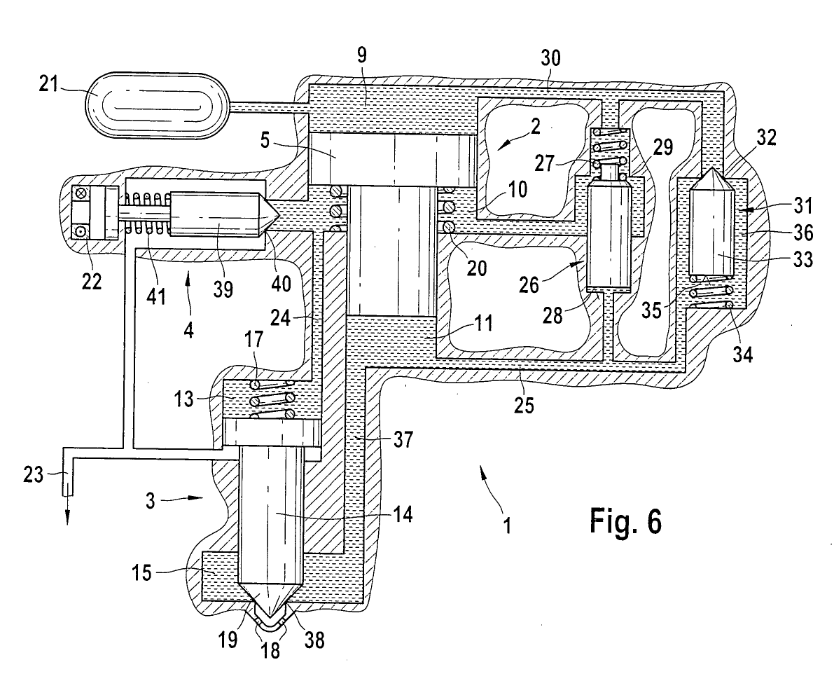

FIG. 6 shows the fuel injection system with the filling valve closing, after refilling of the high-pressure chamber of the pressure boosting system.

Via the filling valve 31, opened at its seat 32 as shown in FIG. 5, fuel flows from the work chamber 9 of the pressure boosting system 2 into the chamber 36 surrounding the valve body 33 of the filling valve 31 and from there on into the high-pressure chamber 11 of the pressure boosting system 2, via the flow connection 29. If substantially the same pressure prevails in both the high-pressure chamber 11 and the work chamber 9 of the pressure boosting system 2, then the valve body 33, because of the spring element 34 acting on its face end 35, is pressed into its seat 32 and prevents the further inflow of fuel into the filling valve 31. This situation shown in FIG. 6 is equivalent to the state of repose, shown in FIG. 2, of the fuel injection system 1 proposed according to the invention.

With the embodiment described above of a fuel injection system 1, a 2/2-way valve 4 of simple construction and two simple, hydraulically actuated check valves, that is, the compensation valve 26 and the filling valve 31, can be used for controlling the injection valve member 14 and for refilling both the high-pressure chamber 11 and the differential pressure chamber 10 (back chamber) of a pressure boosting system 2. With the elimination of throttle restrictions and with the disposition of the simple, hydraulically actuated check valves 26 and 31 as described above, faster triggering of the fuel injector 3 in a way free of outflow losses can be attained. This is attractive in such instances for instance as those in which the advantages of a fuel pressure increase attained by a pressure boosting system 2 are not to be dispensed with, yet an injection course shaping is unnecessary, or the expense for attaining an injection course shaping (the use of two magnet valves as well as end stages required for the purpose in the control unit) does not appear feasible in a self-igniting internal combustion engine.

Other embodiments, although not shown, may for instance provide that the upper end face of the injection valve member 14, embodied for instance as a nozzle needle, can be made to communicate directly with the low-side return 23. In this variant embodiment, the spring 17 received in the control chamber 13 of the fuel injector 3 should be dimensioned suitably more strongly, so that this spring element 17 exerts the closing force that moves the injection valve member 14 into its closing position. In that case, the overflow line 24 between the differential pressure chamber 10 of the pressure boosting system 2 and the control chamber 13 of the fuel injector 3 may be omitted.

Another variant embodiment provides for accommodating the compensation valves 26 and 31, embodied as hydraulically actuated check valves, inside the booster piston 5. In this variant embodiment, the idle volumes included in the flow connection 25, the connecting line 30, and the chambers of both the compensation valve 26 and the filling valve 31 can be avoided. Moreover, in this variant embodiment, the line connections to and from the check valves 26 and 31 are omitted.

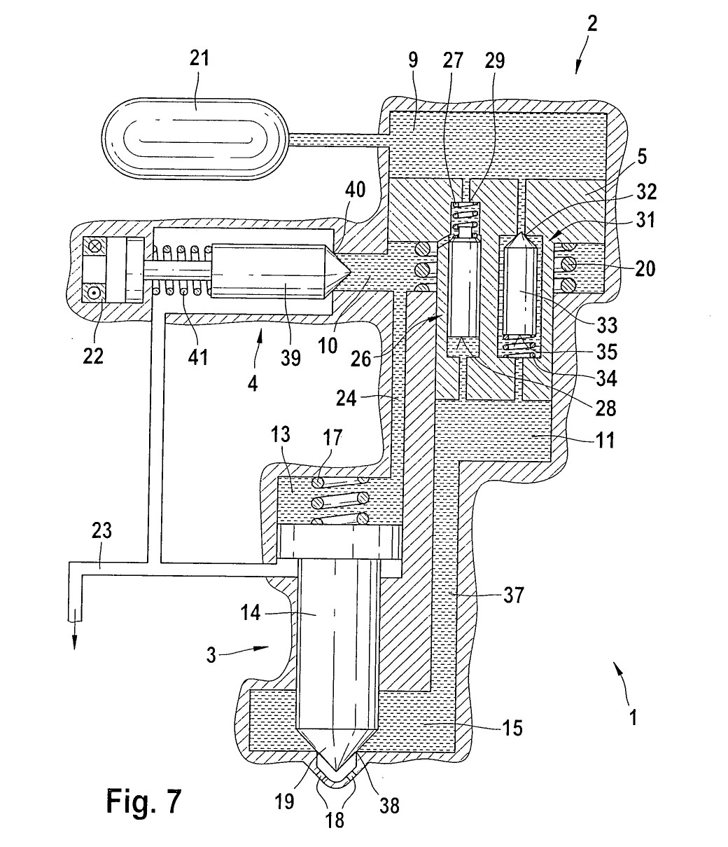

FIG. 7 shows the variant embodiment of the fuel injection system 1 proposed according to the invention in which the check valve acting as a compensation valve 26 and the check valve 31 acting as a filling valve are received inside the booster piston 5.

In this variant embodiment, the work chamber 9 of the pressure boosting system 2 and the high-pressure chamber 11 of the pressure boosting system 2, by way of which the nozzle chamber 15 of the fuel injector 3 is acted upon by fuel, are in fluidic communication via the respective check valves 26 and 31. The valve body 33 of the compensation valve 26 is urged in the opening direction via a spring element 27, while the valve body 33 of the filling valve 31 is urged in the closing direction relative to the seat 32 by a spring element 34 acting on its face end 35. The filling of the differential pressure chamber 10 while the compensation valve 26 is open is effected via a bore between the differential pressure chamber 10 of the pressure boosting system 2 and the chamber that receives the valve body 33 of the compensation valve 26. In the variant embodiment of the invention shown in FIG. 7, a direct communication between the chambers 9 and 10 and the chambers 9 and 11, respectively, can be achieved without there being additional lines or idle volumes. The hydraulic mode of operation of the variant embodiment, shown in FIG. 7, of the fuel injection system 1 proposed according to the invention corresponds to that already described in detail in conjunction with FIGS. 2 through 6. The advantage that can be attained with the variant embodiment of FIG. 7 is the more-compact construction of the fuel injection system 1 proposed according to the invention, while avoiding additional lines as well as additional idle volumes that have to be moved and that impair the efficiency of the fuel injection system 1 proposed according to the invention.

### LIST OF REFERENCE NUMERALS

1 Fuel injection system
2 Pressure boosting system
3 Fuel injector
4 2/2-way valve
5 Booster piston
6 High-pressure pump
7 Fuel tank
8 Fuel supply
9 Work chamber
10 Differential pressure chamber (back chamber)
11 High-pressure chamber
12 Check valve
13 Control chamber of fuel injector
14 Injection valve member
15 Nozzle chamber
16 Triggering valve of fuel injector (2/2-way magnet valve)
17 Closing spring
18 Injection openings
19 Differential surface area (pressure shoulder)
20 Restoring spring
21 High-pressure source (high-pressure reservoir)
22 Magnet coil
23 Low-side return
24 Overflow line to control chamber 13
25 Flow connection between high-pressure chamber and check valves 26, 31
26 Compensation valve
27 Spring element for compensation valve
28 Face end
29 Seat
30 Connecting line from work chamber 9 to check valves 26, 31
31 Filling valve
32 Seat
33 Valve body, filling valve
34 Spring element, filling valve
35 Face end
36 Chamber, filling valve
37 Nozzle chamber inlet
38 Seat, toward the combustion chamber, of injection valve member
39 Valve body of 2/2-way magnet valve
40 Seat
41 Restoring spring

1-11. (canceled)

12. In a fuel injection system for internal combustion engines, having a fuel injector (3) that can be supplied from a high-pressure fuel source (21), in which a pressure boosting system (2) that has a movable booster piston (5) is switched between the fuel injector (3) and the high-pressure fuel source (21), and the booster piston (5) divides a chamber (9), connected to the high-pressure fuel source (21), from a high-pressure chamber (11) communicating with the fuel injector (3) and from a differential pressure chamber (10), and the actuation of the pressure boosting system (2) is effected via a 2/2-way valve assigned to the differential pressure chamber (10), the improvement comprising hydraulically actuated check valves (26, 31) for refilling of the differential pressure chamber (10) and of the high-pressure chamber (11) of the pressure boosting system (2), the hydraulically actuated check valves (26, 31) being acted upon by the pressure level prevailing in the high-pressure chamber (11) upon pressure relief to the differential pressure chamber (10).

13. The fuel injection system of claim 12, wherein the check valve serving to fill the differential pressure chamber (10) is acted upon, as a compensation valve (26), by a spring element (27) acting in the opening direction of the compensation valve (26).

14. The fuel injection system of claim 12, wherein the check valve serving to provide filling is acted upon, as a filling valve (31), by a spring element (34) acting in the closing direction of the filling valve (31).

15. The fuel injection system of claim 12, wherein the check valves (26, 31) are integrated with the booster piston (5) of the pressure boosting system (2).

16. The fuel injection system of claim 15, wherein valve bodies (33) of the check valves (26, 31) each include one end face (28, 35), which end faces can be acted upon hydraulically directly via the high-pressure chamber (11).

17. The fuel injection system of claim 13, wherein the check valve acting as a compensation valve (26) is received in a connecting line (30) between the differential pressure chamber (10) and the work chamber (9) of the pressure boosting system (2).

18. The fuel injection system of claim 14, wherein the check valve acting as a filling valve (31) is received in a flow connection (25, 30) between the high-pressure chamber (11) and the work chamber (9) of the pressure boosting system (2).

19. The fuel injection system of claim 12, wherein the fuel injector (3) comprises a control chamber (13) which communicates hydraulically via an overflow line (24) with the differential pressure chamber (10) of the pressure boosting system (2).

20. The fuel injection system of claim 12, wherein the check valves (26, 31) each comprise seats (29, 32), oriented toward the work chamber (9) of the pressure boosting system (2), which when pressure is exerted on the high-pressure chamber (11) are closed by the valve bodies (33) of the check valves (26, 31).

21. The fuel injection system of claim 19, wherein the control chamber (13) further comprises a closing spring element (17), which urges the injection valve member (14) in the closing direction.

22. The fuel injection system of claim 19, wherein a hydraulically effective surface area of the face end, pointing toward the control chamber (13), of the injection valve member (14) exceeds a differential surface area (19) on the circumference of the injection valve member (14).
